(19) United States
(12) Patent Application Publication
(10) Pub. No.: US 2025/0172912 A1
(43) Pub. Date: May 29, 2025

(54) WEARABLE MEMBER AND WEARABLE ELECTRONIC DEVICE COMPRISING SAME

(71) Applicant: Samsung Electronics Co., Ltd., Suwon-si (KR)

(72) Inventors: Juan LEE, Suwon-si (KR); Insik CHUNG, Suwon-si (KR)

(21) Appl. No.: 19/038,139

(22) Filed: Jan. 27, 2025

Related U.S. Application Data
(63) Continuation of application No. PCT/KR2023/009449, filed on Jul. 5, 2023.

(30) Foreign Application Priority Data
Jul. 27, 2022 (KR) 10-2022-0093440
Oct. 14, 2022 (KR) 10-2022-0132477

(51) Int. Cl. G04B 37/16; A44C 5/14

(52) U.S. Cl. CPC G04B 37/16; A44C 5/147

(57) ABSTRACT

A wearable electronic device according to an embodiment may comprise: a housing and a wearable member. The housing may include a seating area recessed in at least a part of the side surface of the housing. The wearable member may be separably connected to the seating area. The seating area may include at least one first connecting portion on both sidewalls in one axial direction. The wearable member may comprise: a link assembly coupled to the seating area to be releasable therefrom; and a strap. The link assembly may include a pair of first sidewalls, each facing one of the two sidewalls of the housing. The link assembly may include at least one second connecting portion arranged on at least a part of the first sidewalls and engaged with the first 10 connecting portion. The strap may include: a first portion encompassing at least a part of the link assembly; and/or a second portion extending from the first portion. At least a part of the first portion may be arranged between the seating area and the link assembly.

### CROSS-REFERENCE TO RELATED APPLICATIONS

This application is a continuation of International Application No. PCT/KR2023/009449 designating the United States, filed on Jul. 5, 2023, in the Korean Intellectual Property Receiving Office and claiming priority to Korean Patent Application Nos. 10-2022-0093440, filed on Jul. 27, 2022, and 10-2022-0132477, filed on Oct. 14, 2022, in the Korean Intellectual Property Office, the disclosures of each of which are incorporated by reference herein in their entireties.

### BACKGROUND

### Field

The disclosure relates to a detachable wearable member and a wearable electronic device including the same.

### Description of Related Art

Generally, a wearable electronic device may refer to a device that executes a specified function according to a loaded program, such as a home appliance, an electronic notebook, a portable multimedia player, a mobile communication terminal, a tablet PC, a video/audio device, a desktop/laptop computer, or a vehicle navigation device. As the integration level of wearable electronic devices increases and high-speed, large-capacity wireless communication becomes more common, a single electronic device such as a mobile communication terminal may recently be equipped with various functions. For example, in addition to a communication function, an entertainment function such as games, a multimedia function such as music/video playback, a communication and security function for mobile banking, and a function such as schedule management or an electronic wallet are integrated in a single wearable electronic device.

Recently, wearable electronic devices that may be worn on the body have become commercialized, and mobile communication terminals or wearable electronic devices are used in everyday life. Since a wearable electronic device may remain in contact with a user's body for a considerable period of time, it may be usefully utilized in medical or health management. Although the wearable electronic device is generally in the shape of a bar, a box, or a flat plate, it may have a plurality of segments combined in consideration of the convenience of wearing while responding to the curvature of the user's body. For example, a wrist-worn wearable electronic device may include a housing that accommodates various circuit devices and serves as a main body, and at least one wearable member.

The above information is presented as background information simply to assist with an understanding of the disclosure. No determination has been made, and no assertion is made, as to whether any of the above might be applicable as prior art with regard to the disclosure.

### SUMMARY

A wearable electronic device according to an example embodiment of the disclosure includes: a housing and a wearable member including a strap. The housing includes a concave seating area formed on at least a portion of a side surface of the housing. The wearable member is detachably connected to the seating area. The seating area includes at least one first connecting portion on two sidewalls in one axial direction. The wearable member includes a link assembly detachably coupled to the seating area, and a strap. The link assembly includes a pair of first sidewalls facing the two sidewalls of the housing, respectively. The link assembly includes at least one second connecting portion disposed on a portion of the first sidewalls and configured to be engaged with the first connecting portion. The strap includes a first portion surrounding at least a portion of the link assembly, and/or a second portion extending from the first portion. At least a portion of the first portion is disposed between the seating area and the link assembly.

### BRIEF DESCRIPTION OF THE DRAWINGS

The above or other aspects, features, and/or advantages of certain embodiments of the present disclosure will be more apparent from the following detailed description, taken in conjunction with the accompanying drawings, in which:

FIG. 1 is a front perspective view illustrating a wearable electronic device according to various embodiments;

FIG. 2 is a rear perspective view illustrating the wearable electronic device of FIG. 1 according to various embodiments;

FIG. 3 is an exploded perspective view illustrating the wearable electronic device of FIG. 1 according to various embodiments;

FIG. 4 is a perspective view illustrating a housing and a wearable member in a wearable electronic device according to various embodiments;

FIG. 5 is a diagram illustrating a side view of a wearable member according to various embodiments;

FIG. 6 is a perspective view illustrating a link assembly and a strap that are connected to each other in a wearable member according to various embodiments;

FIG. 7 is a perspective view illustrating a wearable member in a first state according to various embodiments;

FIG. 8 is a diagram illustrating a front view of a link assembly of the wearable member of FIG. 7 according to various embodiments;

FIG. 9 is a perspective view illustrating a wearable member in a second state according to various embodiments;

FIG. 10 is a diagram illustrating a front view of a link assembly of the wearable member of FIG. 9 according to various embodiments;

FIG. 11 is a perspective view and a diagram illustrating a housing and a wearable member connected to the housing in a wearable electronic device according to various embodiments;

FIG. 12 is a diagram illustrating a side view of the housing and the wearable member in the wearable electronic device of FIG. 11 according to various embodiments;

FIG. 13 is a perspective view illustrating a wearable member in a wearable electronic device according to various embodiments;

FIG. 14 is a perspective view illustrating a wearable member in a wearable electronic device according to various embodiments;

FIG. 15 is a perspective view illustrating a wearable member in a wearable electronic device according to various embodiments;

FIG. 16 is an exploded perspective view illustrating the wearable member of FIG. 15 according to various embodiments;

FIG. 17 is a perspective view illustrating a wearable member in a wearable electronic device according to various embodiments; and

FIG. 18 is an exploded perspective view illustrating the wearable member of FIG. 17 according to various embodiments.

Throughout the attached drawings, similar reference numbers may be assigned to similar components, configurations, and/or structures.

### DETAILED DESCRIPTION

The following description of the attached drawings may be provided to aid in a comprehensive understanding of various implementations of the disclosure. Various example embodiments disclosed in the following description include various specific details to aid in understanding, but are to be considered as examples. Accordingly, it will be apparent to those skilled in the art that various modifications and variations may be made to the various implementations of the disclosure without departing from the scope and technical spirit of the disclosure. Further, a description of well-known functions and configurations may be omitted for clarity and conciseness.

The terms and words used in the following description and claims may be used to clearly and consistently describe various embodiments of the disclosure, not limited to referential meanings. Accordingly, it will be apparent to those skilled in the art that the following description of various implementations of the disclosure is provided for illustrative purposes, not for the purpose of limiting the disclosure.

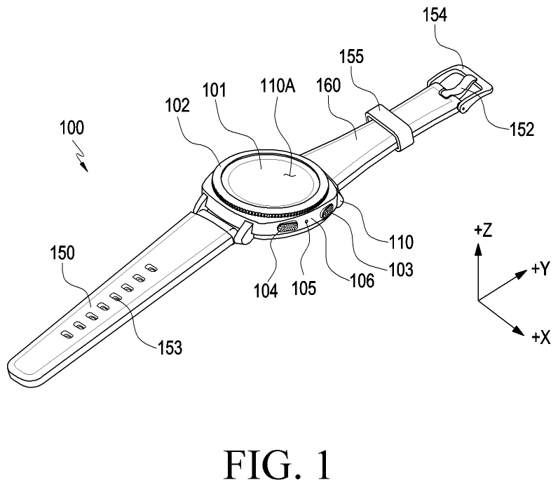

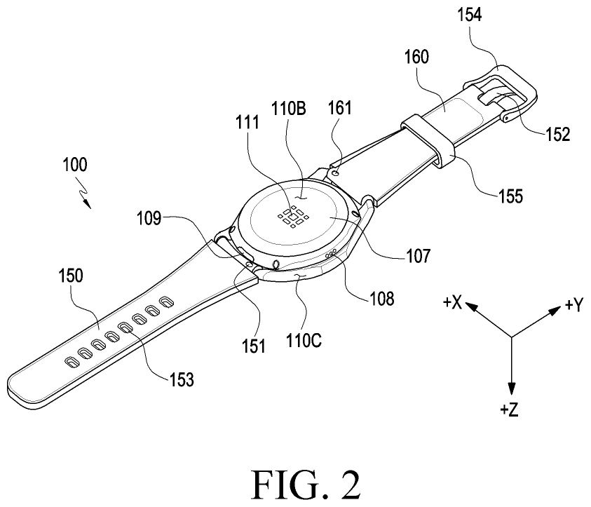

FIG. 1 is a front perspective view illustrating an example wearable electronic device 100 according to various embodiments. FIG. 2 is a rear perspective view illustrating the wearable electronic device 100 of FIG. 1 according to various embodiments.

In the following description, in a Cartesian coordinate system of FIGS. 1 to 3, an ‘X-axis direction’ may refer to a width direction of the wearable electronic device 100 or a housing 110, a ‘Y-axis direction’ may refer to a longitudinal direction of the wearable electronic device 100 or the housing 110, and a ‘Z-axis direction’ may refer to a thickness direction of the wearable electronic device 100 or the housing 110. In an embodiment, a direction in which a front surface (e.g., a first surface 110A in FIG. 1) of the wearable electronic device 100 or the housing 110 faces may be defined as a ‘first direction’ or a ‘+Z direction’, and a direction in which a rear surface (e.g., a second surface 110B in FIG. 2) of the wearable electronic device 100 or the housing 110 faces may be defined as a ‘second direction’ or a ‘−Z direction’.

Referring to FIGS. 1 and 2, the wearable electronic device 100 according to an embodiment may include the housing 110 which includes the first surface (or front surface) 110A, the second surface (or rear surface) 110B, and a side surface 110C surrounding a space between the first surface 110A and the second surface 110B, and wearable members 150 and 160 connected to at least a portion of the housing 110 and configured to be detachably fasten the wearable electronic device 100 to a user's body part (e.g., wrist or ankle). For example, the wearable electronic device 100 may be in the shape of a wrist watch. In an embodiment (not shown), the housing may refer to a structure that forms portions of the first surface 110A, the second surface 110B, and the side surface 110C of FIG. 1. According to an embodiment, at least a portion of the first surface 110A may be formed by a front plate 101 (e.g., a glass plate or polymer plate including various coating layers) which is at least partially substantially transparent. The second surface 110B may be formed by a substantially opaque rear plate 107. The rear plate 107 may be formed of, for example, coated or tinted glass, ceramic, a polymer, a metal (e.g., aluminum, stainless steel (STS), or magnesium), or a combination of at least two of these materials. The side surface 110C may be formed by a side bezel structure (or “side member”) 106 coupled to the front plate 101 and the rear plate 107 and including a metal and/or a polymer. In various embodiments, the rear plate 107 and the side bezel structure 106 may be integrally formed and include the same material (e.g., a metal material such as aluminum). The wearable members 150 and 160 may be formed of any of various materials in any of various shapes. A woven fabric, leather, rubber, urethane, a metal, ceramic, or a combination of at least two of these materials may be used to form an integrated type and a plurality of unit links to be movable with each other.

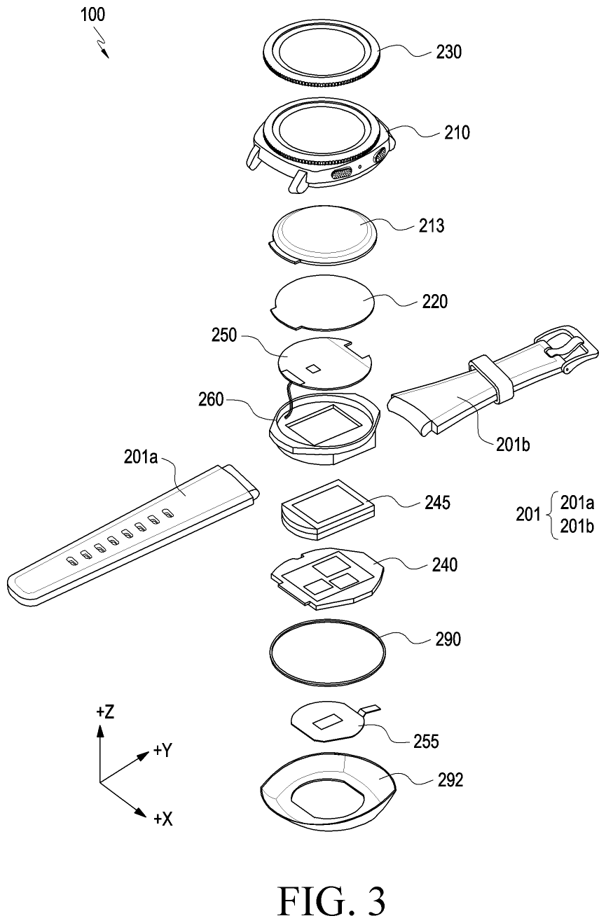

According to an embodiment, the wearable electronic device 100 may include at least one of a display 220 (see FIG. 3), audio modules 105 and 108, a sensor module 111, key input devices 102, 103 and 104, or a connector hole 109. In various embodiments, the wearable electronic device 100 may not be provided with at least one (e.g., the key input devices 102, 103 and 104, the connector hole 109, or the sensor module 111) of the components or additionally include other components.

According to an embodiment, the display (e.g., the display 220 in FIG. 3) may be visible, for example, through a substantial portion of the front plate 101. The shape of the display 220 may correspond to that of the front plate 101, and may be any of various types such as a circle, an oval, or a polygon. The display 220 may be incorporated with or disposed adjacent to a touch sensing circuit, a pressure sensor that measures the intensity (pressure) of a touch, and/or a fingerprint sensor.

The audio modules 105 and 108 may include a microphone hole 105 and a speaker hole 108. A microphone for obtaining an external sound may be disposed in the microphone hole 105. For example, a plurality of microphones may be disposed within the microphone hole 105 to detect the direction of a sound. The speaker hole 108 may be used as an external speaker and a receiver for calls. For example, a speaker (e.g., a piezo speaker) may be included without the speaker hole.

The sensor module 111 may include at least one sensor and generate an electrical signal or data value corresponding to an internal operation state of the wearable electronic device 100 or an external environmental state. The sensor module 111 may include, for example, a biometric sensor module 111 (e.g., a HRM sensor) disposed on the second surface 110B of the housing 110. The wearable electronic device 100 may further include a sensor module (not shown), for example, at least one of a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illuminance sensor.

The key input devices 102, 103, and 104 may include a wheel key 102 disposed on the first surface 110A of the housing 110 and rotatable in at least one direction, and/or side key buttons 103 and 104 disposed on the side surface 110C of the housing 110. The wheel key 102 may have a shape corresponding to that of the front plate 101. In an embodiment, the wearable electronic device 100 may not include some or any of the above-mentioned key input devices 102, 103, and 104, and the key input devices 102, 103, and 104 which are not included may be implemented in another form such as a soft key on the display 220. The connector hole 109 may accommodate a connector (e.g., a USB connector) for transmitting and receiving power and/or data to and from an external wearable electronic device, and another connector hole (not shown) for accommodating a connector for transmitting and receiving an audio signal to and from an external wearable electronic device. The wearable electronic device 100 may further include, for example, a connector cover (not shown) that covers at least a portion of the connector hole 109 and blocks the introduction of a foreign material into the connector hole.

The wearable members 150 and 160 may be detachably fastened to at least a partial area of the housing 110 using locking members 151 and 161. The locking members 151 and 161 may include a fastening component such as a pogo pin, and may be replaced by protrusion(s) or recess(es) formed on the wearable members 150 and 160 according to an embodiment. For example, the wearable members 150 and 160 may be coupled in a manner that they are engaged with recesses or protrusions formed on the housing 110. The wearable members 150 and 160 may include one or more of a fixing member 152, a fixing member fastening hole 153, a band guide member 154, and a band fixing loop 155.

The fixing member 152 may be configured to fix the housing 110 and the wearable members 150 and 160 to the user's body part (e.g., a wrist or an ankle). The fixing member fastening hole 153 may fix the housing 110 and the wearable members 150 and 160 to the user's body part in correspondence with the fixing member 152. The band guide member 154 may be configured to limit a movement range of the fixing member 152, when the fixing member 152 is fastened in the fixing member fastening hole 153, so that the wearable members 150 and 160 are fastened to the user's body part in close contact. The band fixing loop 155 may limit movement ranges of the wearable members 150 and 160, with the fixing member 152 fastened in the fixing member coupling hole 153.

FIG. 3 is an exploded perspective view illustrating the wearable electronic device of FIG. 1 according to various embodiments.

Referring to FIG. 3, the wearable electronic device 100 may include a side bezel structure 212, a wheel key 230, a front plate 213 (e.g., the front plate 101 in FIG. 1), the display 220, a first antenna 250, a second antenna (e.g., an antenna included in a second circuit board 255), a support member 260 (e.g., a bracket), a battery 245, a printed circuit board 240, a sealing member 290, a rear plate 292, and a wearable member 201. At least one of the components of the wearable electronic device 100 may be the same as or similar to at least one of the components of the electronic device 101 of FIG. 1 or FIG. 2, and a redundant description will be avoided herein. The support member 260 may be disposed inside the wearable electronic device 100 and connected to the side bezel structure 212, or may be integrally formed with the side bezel structure 212. The support member 260 may be formed of, for example, a metal material and/or a non-metal (e.g., polymer) material. The support member 260 may have one surface coupled to the display 220 and the other surface coupled to the printed circuit board 240. A processor, memory, and/or an interface may be mounted on the printed circuit board 240. The processor may include, for example, at least one of a central processing unit (CPU), an application processor (AP), a graphic processing unit (GPU), an AP sensor processor, or a communication processor.

The memory may include, for example, volatile memory or non-volatile memory. The interface may include, for example, a high definition multimedia interface (HDMI), a universal serial bus (USB) interface, an SD card interface, and/or an audio interface. The interface may, for example, electrically or physically connect the wearable electronic device 100 to an external electronic device, and include a USB connector, an SD card/MMC connector, or an audio connector.

The battery 245 is a device for supplying power to at least one component of the wearable electronic device 100, and may include, for example, a non-rechargeable primary battery, a rechargeable secondary battery, or a fuel cell. At least a portion of the battery 245 may be disposed substantially on the same plane as the printed circuit board 240. The battery 245 may be integrally disposed inside the wearable electronic device 100 or disposed detachably from the wearable electronic device 100.

The first antenna 250 may be disposed between the display 220 and the support member 260. The first antenna 250 may include, for example, a near field communication (NFC) antenna, a wireless charging antenna, and/or a magnetic secure transmission (MST) antenna. The first antenna 250 may, for example, perform short-range communication with an external device, wirelessly transmit and receive power required for charging, and transmit a short-range communication signal or a magnetic-based signal including payment data. In an embodiment, an antenna structure may be formed by a portion of the side bezel structure 212 and/or the support member 260 or a combination of them.

The second circuit board 255 may be disposed between the printed circuit board 240 and the rear plate 292. The second circuit board 255 may include, for example, an NFC antenna, a wireless charging antenna, and/or an MST antenna. The second circuit board 255 may, for example, perform short-range communication with an external device, wirelessly transmit and receive power required for charging, and transmit a short-range communication signal or a magnetic-based signal including payment data. In an embodiment, an antenna structure may be formed by a portion of the side bezel structure 212 and/or the rear plate 292 or a combination of them. In various embodiments, when the wearable electronic device 100 (e.g., the wearable electronic device 100 in FIGS. 1 and 2) includes a sensor module (e.g., the sensor module 111 in FIG. 2), a sensor circuit may be disposed on the second circuit board 255 or a sensor element (e.g., a photoelectric conversion element or an electrode pad) may be disposed separately from the second circuit board 255. For example, an electronic component provided as the sensor module 111 may be disposed between the printed circuit board 240 and the rear plate 292.

The sealing member 290 may be located between the side bezel structure 212 and the rear plate 292. The sealing member 290 may be configured to block the introduction of moisture and a foreign material from the outside into a space surrounded by the side bezel structure 212 and the rear plate 292.

The wearable member 201 may be provided as a pair of wearable members 201a and 201b. For example, the pair of wearable members 201a and 201b may be connected to different areas of the side bezel structure 212 and disposed in a symmetrical shape.

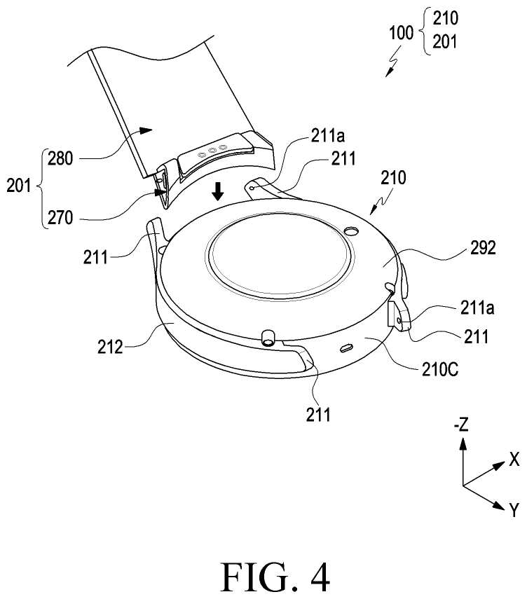

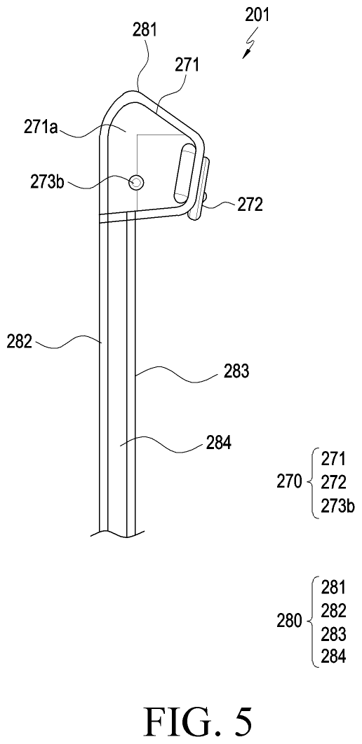

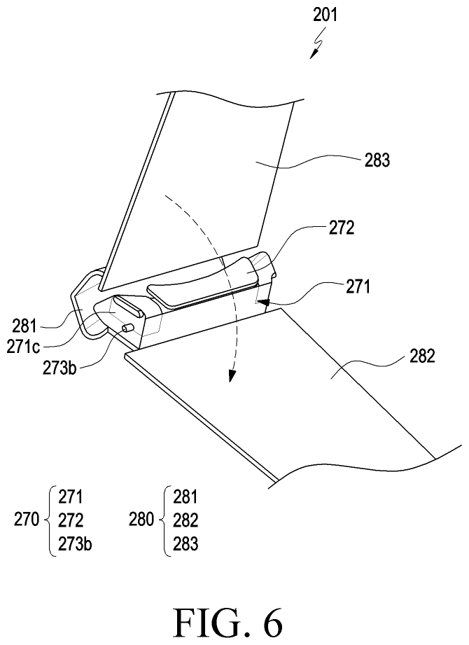

FIG. 4 is a partially exploded perspective view illustrating a housing and a wearable member in a wearable electronic device according to various embodiments. FIG. 5 is a diagram illustrating a side view of a wearable member according to various embodiments. FIG. 6 is a perspective view illustrating a link assembly and a strap connected to each other in a wearable member according to various embodiments.

For the wearable electronic device 100 of FIG. 4, the wearable electronic device 100 of FIGS. 1, 2 and 3 may be referred to. The configuration of the wearable member 201 in FIGS. 4, 5 and 6 (which may be referred to as FIGS. 4 to 6) may be wholly or partially the same as or similar to the configuration of the wearable members 150 and 160 in FIGS. 1 and 2 and/or the wearable member 201 in FIG. 3.

Referring to FIGS. 4 to 6, the wearable electronic device 100 according to various embodiments of the disclosure may include the housing 210 (e.g., the housing 110 in FIGS. 1 and 2) and/or at least one wearable member 201. For example, the housing 210 may include a side bezel structure (e.g., the side bezel structure 212 in FIG. 4) and a rear plate (e.g., the rear plate 292 in FIG. 3).

According to an embodiment, the wearable member 201 may be configured to detachably fasten the housing 210 or the wearable electronic device 100 to a user's body (e.g., wrist). For example, a plurality (e.g., a pair) of wearable members 201 may be provided and located symmetrically with respect to the housing 210. For example, as described with reference to the wearable electronic device 100 of FIGS. 1, 2 and 3, the user may wear the wearable electronic device 100 on the body by fastening the pair of wearable members 201.

Referring to FIG. 4, in an embodiment, the housing 210 may include at least one seating area 217 on a portion of a side surface 210C (e.g., the side surface 110C in FIGS. 1 and 2). According to an embodiment, the wearable member 201 may be detachably mounted in the seating area 217. For example, the seating area 217 may be a concave area formed on a portion of the side surface 210C of the housing 210. For example, the wearable member 201 may be at least partially accommodated in the seating area 217. According to an embodiment, the seating area 217 may refer to an area surrounded by a plurality (e.g., a pair) of protrusions 211 (e.g., lugs 211) and the side surface 210C of the housing 210 located between the pair of protrusions 211. For example, a pair of protrusions 211 may be provided spaced apart from each other on the side surface 210C of the housing 210. For example, a plurality (e.g., a pair) of seating areas 217 may be disposed symmetrically with respect to the housing 210. For example, the protrusions 211 of the seating area 217 may be formed integrally with the housing 210 or may be coupled to the housing 210. For example, at least one of the pair of protrusions 211 in the seating area 217 may be provided as a single member with the closer protrusion 211 out of the pair of protrusions 211 of the other seating area 217 disposed on the opposite side, and coupled to the side surface 210C of the housing 210.

According to an embodiment, the protrusions 211 may include first connecting portions 211a connected to portions (e.g., second connecting portions 273b) of the wearable member 201, on sidewalls thereof in a first axial direction (e.g., the X-axis direction). For example, the first connecting portions 211a may be grooves recessed into facing surfaces of the sidewalls of the pair of protrusions 211. However, for example, the first connecting portions 211a may be formed to have a shape corresponding to the shape of the second connecting portions 273b so as to be able to accommodate the second connecting portions 273b of the wearable member 201. However, the shapes and/or positions of the seating area 217 and the first connecting portions 211a are not limited to those described above, and as long as they are a structure detachably connected to the wearable member 201, their specific shapes and positions may be changed and applied in various manners.

Referring to FIGS. 5 and 6, in an embodiment, the wearable member 201 may include a link assembly 270 and a strap 280.

According to an embodiment, the link assembly 270 may include a body 271, a button member 272, and the second connecting portions 273b engaged with portions (e.g., the first connecting portions 211a) of the seating area 217.

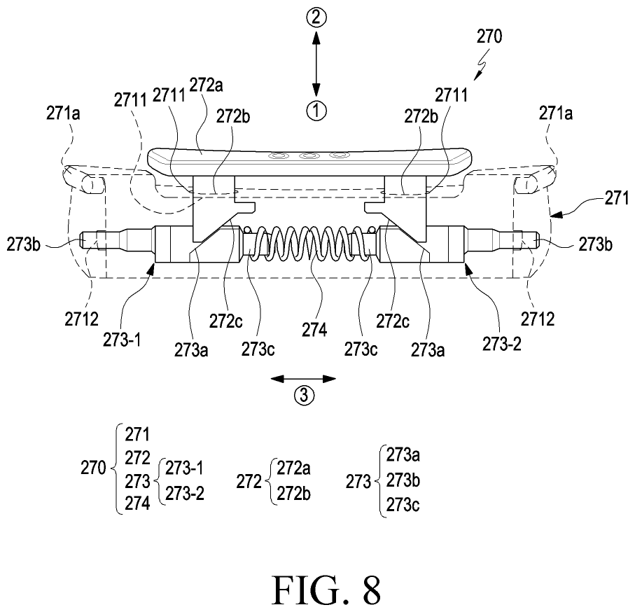

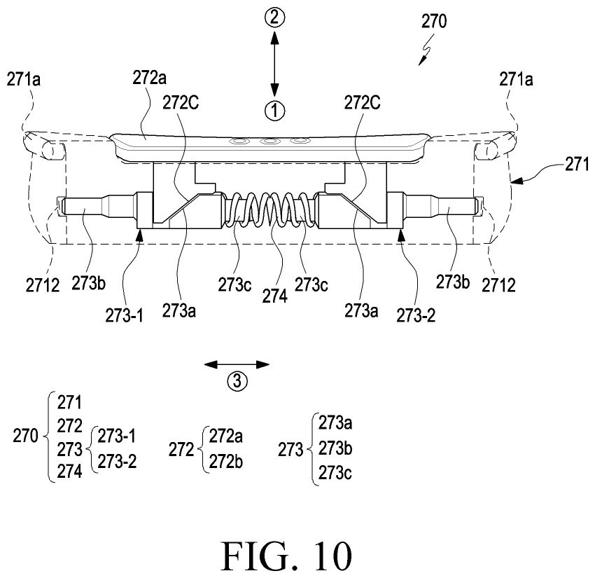

According to an embodiment, the body 271 may include a pair of first sidewalls 271c each facing one surface of the pair of protrusions 211 that form the seating area 217. For example, both of the first sidewalls 271c may be sidewalls of the body 271 in the first axial direction (e.g., the X-axis direction). According to an embodiment, the body 271 may include second openings (e.g., second openings 2712 in FIGS. 8 and 10) on the first sidewalls 271c, through which the second connecting portions 273b pass.

According to an embodiment, the second connecting portions 273b may be disposed adjacent to the second openings 2712 formed on the first sidewalls 271c. For example, the second connecting portions 273b may pass through the second openings 2712, be exposed at least partially to the outside of the first sidewalls 271c, and be coupled to the first connecting portions 211a of the seating area 217. For example, the second connecting portions 273b may be concealed inside the first sidewalls 271c through the second openings 2712 and disengaged from the first connecting portions 211a of the seating area 217. For example, the first connecting portions 211a and the second connecting portions 273b may be the protrusions 211 and concave portions that are engaged with each other, or vice versa. The link assembly 270 may be mounted in or separated from the seating area 217 of the housing 210 by the operation of the second connecting portions 273b described above.

In an embodiment, the strap 280 may be detachably connected to the link assembly 270. Referring to FIG. 6, the strap 280 may be coupled to the link assembly 270 in a form that surrounds a portion of the link assembly 270. In an embodiment, the strap 280 may include a first portion 281 and second portions 282 and 283. For example, the first portion 281 and the second portions 282 and 283 may be formed integrally, or may be separated for convenience of description. For example, the first portion 281 may be supported by the link assembly 270, and the second portions 282 and 283 may be portions supported by the user's body (e.g., wrist). For example, the first portion 281 of the strap 280 may be formed in a form that surrounds an area excluding a portion (e.g., the button member 272 and the first sidewalls 271c) of the link assembly 270. For example, the second portions 282 and 283 of the strap 280 may extend from the first portion 281 in at least one direction (e.g., in the longitudinal direction of the wearable electronic device 100 or the Y-axis direction). For example, at least the first portion 281 of the strap 280 may be formed of any of various flexible materials (e.g., fabric or leather).

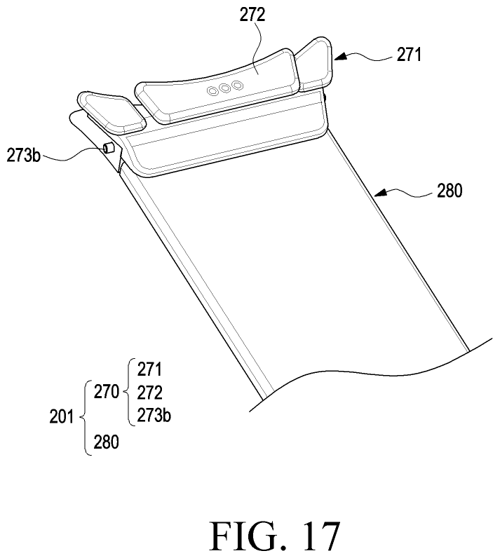

In an embodiment, a plurality (e.g., a pair) of second portions 282 and 283 may be provided. For example, a pair of second portions 282 and 283 may extend from both ends (e.g., both ends in the Y-axis direction) of the first portion 281. According to an embodiment, when the wearable electronic device 100 is worn on the user's body, the second portions 282 and 283 may include a (2-1)^{th} portion 282 forming an outer surface of the wearable member 201 and a (2-2)^{th} portion 283 that comes into contact with the user's body. For example, the (2-1)^{th} portion 282 and the (2-2)^{th} portion 283 may be spaced apart from each other with an intermediate member 284 interposed therebetween. For example, the intermediate member 284 may be fixed to one surface of the (2-1)^{th} portion 282 and/or the (2-1)^{th} portion 283 and connect the (2-1)^{th} portion 282 and the (2-1)^{th} portion 283. In an embodiment (e.g., see FIG. 17), the second portions 282 and 283 of the strap 280 may be formed as a single member, extending from the first portion 281 and a portion of the first portion 281. For example, the second portions 282 and 283 may include the (2-1)^{th} portion 282 and the (2-1)^{th} portion 283 parallel to each other with or without the intermediate member 284 therebetween. For example, since the strap 280 is repeatedly attachable to and detachable from the link assembly 270, the user may use the wearable member 201 in a manner that replaces multiple straps 280 for the single link assembly 270.

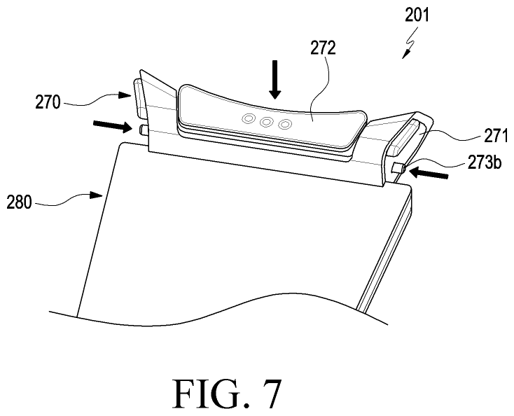

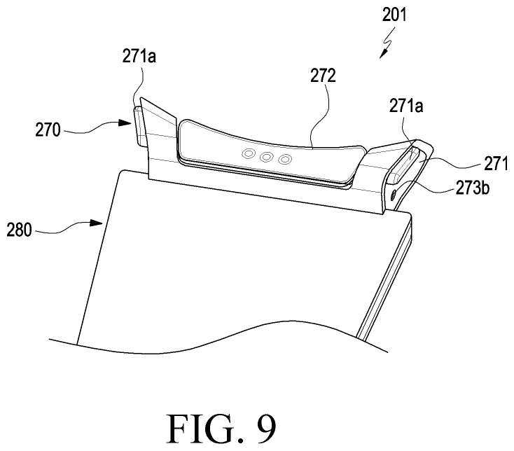

FIG. 7 is a perspective view illustrating a wearable member in a first state according to various embodiments. FIG. 8 is a diagram illustrating a front view of the link assembly of the wearable member of FIG. 7. FIG. 9 is a perspective view illustrating the wearable member in a second state according to an embodiment of the disclosure. FIG. 10 is a diagram illustrating a front view illustrating the link assembly of the wearable member of FIG. 9 according to various embodiments.

The configuration of the wearable member 201 in FIGS. 7, 8, 9 and 10 (which may be referred to as FIGS. 7 to 10) may be wholly or partially the same as or similar to the configuration of the wearable member 201 in FIGS. 4 to 6. For the link assembly 270 and the strap 280 of FIGS. 7 to 10, the link assembly 270 and the strap 280 of FIGS. 4 to 6 may be referred to, respectively. For some of the components, the description of the components to which the same reference numerals are assigned in the previously referenced drawings may be applied, and a redundant description may not be repeated here.

In an embodiment, the link assembly 270 may be changed between the first state (e.g., FIGS. 7 and 8) in which the button member 272 (e.g., the button member 272 in FIGS. 5 and 6) is not pressed and the second connecting portions 273b protrude and the second state (e.g., FIGS. 9 and 10) in which the button member 272 is pressed and the second connecting portions 273b are concealed. In an embodiment, the wearable member 201 may be mounted in or removed from the seating area 217 (e.g., the seating area 217 in FIG. 4) of the housing 210 (e.g., the housing 210 in FIG. 4), with the link assembly 270 maintained in the second state.

Hereinafter, a direction in which the button member 272 moves by an external input (e.g., pressure or touch) and an elastic force of a spring member 274 may be referred to as a first axial direction (e.g., arrowed directions \textcircled{1} and \textcircled{2}). A direction in which a spring bar 273 moves by an external input transmitted by the button member 272 and/or an elastic force of the spring member 274 may be referred to as a second axial direction (e.g., an arrowed direction \textcircled{3}). The first axial direction and the second axial direction may intersect (e.g., be orthogonal to each other). For example, the first axial direction may be substantially parallel to the Z axis. For example, the second axial direction may be substantially parallel to the X axis.

Referring to FIGS. 8 and 10, in an embodiment, the link assembly 270 may include the body 271, the button member 272, the spring bar 273, and/or the spring member 274.

According to an embodiment, the body 271 may be formed in a shape corresponding to that of the seating area 217 (e.g., the seating area 217 in FIG. 4) of the housing 210 (e.g., the housing 210 in FIG. 4). According to an embodiment, the body 271 may form an internal space that at least partially accommodates the remaining components (e.g., the button member 272, the spring bar 273, and/or the spring member 274) of the link assembly 270. According to an embodiment, the body 271 may include a first opening 2711 through which a portion (e.g., an extension portion 272b) of the button member 272 passes, in a portion of an area overlapping the button member 272. For example, the first opening 2711 may be a hole formed to penetrate through a sidewall facing the button member 272 in the first axial direction (e.g., in the arrowed directions \textcircled{1} and \textcircled{2}). According to an embodiment, the second openings 2712 may be formed in portions of the body 271 to accommodate the second connecting portions 273b formed at ends of the spring bar 273. For example, the second openings 2712 may be holes formed to penetrate through second axial-direction sidewalls in the second axial direction (e.g., in the arrowed direction \textcircled{3}). For example, the first opening 2711 and the second openings 2712 may be connected to the internal space of the body 271 in which a portion (e.g., the extension portion 272b) of the button member 272, the remaining portion of the spring bar 273, and the spring are accommodated.

For example, a portion of the internal space may be formed to guide movement of the button member 272 in the first axial direction (e.g., the arrowed directions \textcircled{1} and \textcircled{2}). For example, the spring bar 273 may be disposed to be slidable in the second axial direction (e.g., the arrowed direction \textcircled{3}) in the internal space of the body 271. For example, a portion of the internal space may be formed to guide the movement of the spring bar 273 in the second axial direction (e.g., the arrowed direction \textcircled{3}). For example, a partial area overlapping the button member 272 may be concavely formed in the body 271, and an input portion 272a of the button member 272 may be seated in the area.

In an embodiment, the button member 272 may include the input portion 272a protruding outward from the body 271 and at least one extension portion 272b extending from the input portion 272a toward the inside of the body 271. For example, the input portion 272a may receive an external input (e.g., touch or pressure) such as a user's click operation. In an embodiment, a plurality (e.g., a pair) of extension portions 272b may be provided. For example, a pair of extension portions 272b may be included. For example, the pair of extension portions 272b may be spaced apart from each other in the second axial direction (e.g., the arrowed direction \textcircled{3}). For example, the input portion 272a may include at least one protrusion on a surface thereof. For example, the at least one protrusion may help the user to tactilely recognize the button member 272.

According to an embodiment, the button member 272 may be disposed not to be exposed to the outside together with the (2-2)^{th} portion 283 of the strap 280, when the user wears the wearable electronic device 100 on the body part (e.g., wrist) using the wearable member 201. For example, the input portion 272a of the button member 272 may be disposed parallel to the rear plate (e.g., the rear plate 107 in FIG. 2, the rear plate 292 in FIG. 3, and/or the rear plate 292 in FIG. 4) of the wearable electronic device 100 in a lateral direction (e.g., the Y-axis direction). For example, the input portion 272a may face substantially the same or similar direction (e.g., the −Z direction) to the (2-2)^{th} portion 283 forming the inner surface of the strap 280. However, the arrangement of the button member 272 is not limited thereto. For example, the button member 272 may be disposed to be exposed on a top sidewall (e.g., a +Z direction sidewall) of the body 271.

According to an embodiment, the input portion 272a of the button member 272 may receive an external input (e.g., a touch or a pressure force) and transmit it to the spring bar 273 disposed in the body 271. In an embodiment, the extension portion 272b of the button member 272 may include a first inclined surface 272c at an end thereof opposing the input portion 272a. For example, the first inclined surface 272c may contact a second inclined surface 273a of the spring bar 273 by being engaged with the second inclined surface 273a, and transmit the external input to the spring bar 273. According to an embodiment, the first inclined surface 272c and the second inclined surface 273a may be formed to move the spring bar 273 in the second axial direction (e.g., the arrowed direction \textcircled{3}) intersecting the first axial direction (e.g., the arrowed directions \textcircled{1} and \textcircled{2}) in which the button member 272 moves. According to an embodiment, a plurality (e.g., a pair) of extension portions 272b may be provided. For example, each of the first inclined surfaces 272c of the pair of extension portions 272b may have a symmetrical shape with respect to the first axial direction (e.g., the arrowed directions \textcircled{1} and \textcircled{2}). For example, each of the first inclined surfaces 272c of the pair of extension portions 272b may have a shape inclined so as to become farther away from each other along the first direction (e.g., the arrowed direction \textcircled{1}).

In an embodiment, a plurality (e.g., a pair) of spring bars 273 may be provided, and a pair of spring bars 273 may include a first spring bar 273-1 and a second spring bar 273-2 spaced apart from each other. According to an embodiment, the first spring bar 273-1 and the second spring bar 273-2 may be spaced apart from each other with the spring member 274 therebetween. According to an embodiment, portions (e.g., the second inclined surfaces 273a) of the first spring bar and the second spring bar 273-2 may be respectively connected to the pair of extension portions 272b of the button member 272. In an embodiment, the spring bar 273 may be in a form that extends in the second axial direction (e.g., in the arrowed direction \textcircled{3}).

In an embodiment, each of the first spring bar 273-1 and the second spring bar 273-2 may include a first end and a second end 273c opposite to each other in the second axial direction (e.g., the arrowed direction \textcircled{3}). According to an embodiment, the spring bar 273 may include the second connecting portions 273b at the first ends. For example, in a state where there is no external input through the button member 272, the second connecting portions 273b of the spring bar 273 may protrude from the outer surface of the body 271 due to an elastic force of the spring member 274. For example, the second connecting portions 273b may be formed to be engaged with the first connecting portions 211a formed in the seating area 217 (e.g., the seating area 217 in FIG. 4) of the housing 210 (e.g., the housing 210 in FIG. 4). For example, the second connecting portions 273b may be in the shape of pins that may be accommodated in the first connecting portions 211a having a groove shape.

According to an embodiment, the spring bar 273 may be connected to the spring member 274 through the second ends 273c. For example, the spring bar 273 may have the second ends 273c, which are opposite to the first ends, in contact with the spring member 274. For example, the second ends 273c may be at least partially accommodated in the spring member 274.

According to an embodiment, the spring bar 273 may include the second inclined surfaces 273a engaged with the first inclined surfaces 272c. For example, each of the first spring bar 273-1 and the second spring bar 273-2 may include a second inclined surface 273a engaged with the first inclined surface 272c of each of the pair of extension portions 272b. For example, the second inclined surfaces 273a of the first spring bar 273-1 and the second spring bar 273-2 may be inclined to be closer to each other along the second direction (e.g., the arrowed direction \textcircled{2}).

In an embodiment, the spring member 274 may be disposed between the first spring bar 273-1 and the second spring bar 273-2. For example, the spring member 274 may be in the form of a coil wound along the second axial direction (e.g., the arrowed direction \textcircled{3}). In an embodiment, the spring member 274 may be provided as a single member and apply an elastic force to the first connecting portions 211a and the second connecting portions 273b.

With reference to FIGS. 7 to 10, the first state and the second state of the link assembly 270 will be described.

In an embodiment, when the link assembly 270 is in the first state (e.g., FIGS. 6 to 8), the second connecting portions 273b may protrude outward from the body 271 and be coupled to the first connecting portions 211a. For example, when the link assembly 270 is in the second state (e.g., FIGS. 9 and 10), the second connecting portions 273b may be retracted into the body 271 and decoupled from the first connecting portions 211a. For example, in the second state (e.g., FIGS. 9 and 10), the wearable member 201 may be separated from the seating area 217.

Referring to FIGS. 7 to 10, when the button member 272 is displaced in the first direction (e.g., the arrowed direction \textcircled{1}) by an external input, the second inclined surfaces 273a of the spring bar 273 may slide along the first inclined surfaces 272c, thereby causing the spring bar 273 to move toward the spring member 274. For example, the first spring bar 273-1 and the second spring bar 273-2 may move closer to each other in the second axial direction (e.g., the arrowed direction \textcircled{3}). Accordingly, each of the second connecting portions 273b of the first spring bar 273-1 and the second spring bar 273-2 may be accommodated inside the body 271. According to an embodiment, in the second state, the spring member 274 may be compressed by the first spring bar 273-1 and the second spring bar 273-2. For example, when the external input is removed in the second state, the link assembly 270 may return to the first state. For example, when the external input is removed, the first spring bar 273-1 and the second spring bar 273-2 may move away from each other in the second axial direction (e.g., the arrowed direction \textcircled{3}) by the elastic force of the spring member 274. As the first inclined surfaces 272c of the button member 272 slide along the second inclined surfaces 273a by the movement of the spring bar 273, the button member 272 may move in the second direction (e.g., the arrowed direction \textcircled{2}). For example, the second state illustrated in FIGS. 8 and 10 may represent a state in which the button member 272 and the spring bar 273 are maximally displaced from the first state. For example, the button member 272 may include stopper portions formed to protrude from ends of the first inclined surfaces 272c to limit the sliding movement of the second inclined surfaces 273a. For example, the movement of the spring bar 273 may be limited in the second state.

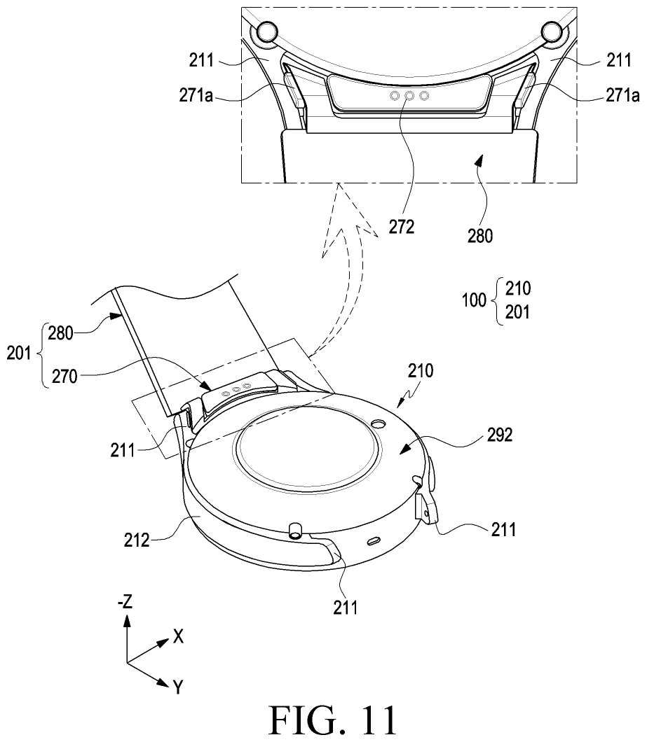

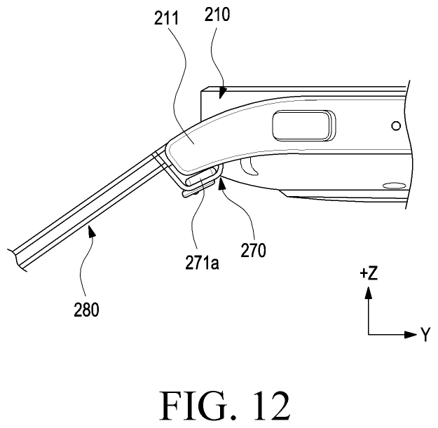

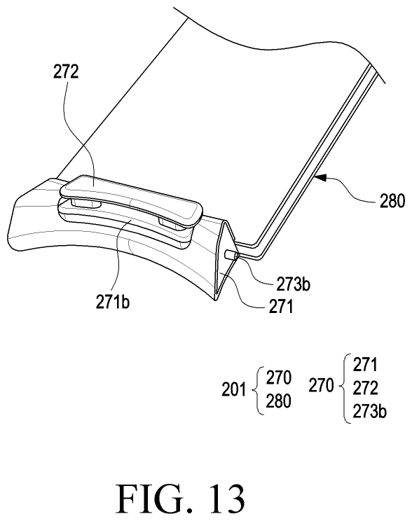

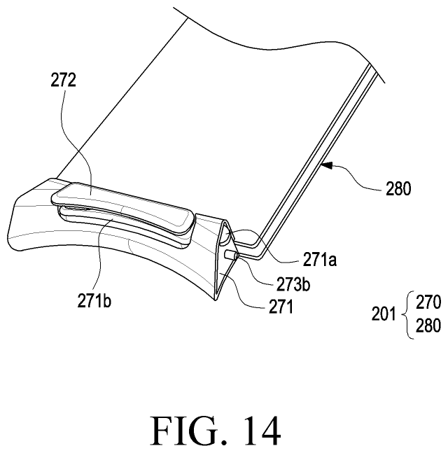

FIG. 11 includes a perspective view and a diagram illustrating a housing and a portion of a wearable member connected to the housing in a wearable electronic device according to various embodiments. FIG. 12 is a diagram illustrating a side view of the housing and the wearable member in the wearable electronic device of FIG. 11 according to various embodiments. FIG. 13 is a perspective view illustrating the wearable member in the wearable electronic device according to various embodiments. FIG. 14 is a perspective view illustrating the wearable member in the wearable electronic device according to various embodiments.

The configuration of the wearable member 201 in FIGS. 11, 12, 13 and 14 (which may be referred to as FIGS. 11 to 14) may be wholly or partially the same as or similar to the configuration of the wearable member 201 in FIGS. 7 to 10. For the link assembly 270 and the strap 280 of FIGS. 11 to 14, the link assembly 270 and the strap 280 of FIGS. 7 to 10 may be referred to, respectively. For some of the components, the description of the components to which the same reference numerals are assigned in the previously referenced drawings may be applied, and a redundant description may not be repeated here.

Referring to FIGS. 11 and 12, in an embodiment, the wearable member 201 (or the body 271) may include at least one wing portion 271a formed to protrude from a portion of the body 271. According to an embodiment, the wing portion 271a may be formed to overlap a portion of the housing 210 adjacent to the seating area 217, with the link assembly 270 mounted in the seating area 217 of the housing 210. For example, a plurality (e.g., a pair) of wing portions 271a may be provided. According to an embodiment, a pair of wing portions 271a may be formed to protrude respectively from both sidewalls in the second axial direction (e.g., the X-axis direction). For example, the wing portion 271a may be connected to one surface of the body 271 on which the button member 272 is disposed. For example, the wing portion 271a may be disposed adjacent to or in contact with the overlapping portion of the housing 210. For example, the wing member 271a may help the link assembly 270 to be fixedly mounted without rotation relative to the seating area 217 of the housing 210. For example, the wing portion may guide the link assembly 270 to a position where the second connecting portions 273b of the link assembly 270 are engaged with the first connecting portions 211a of the seating area 217, when the wearable member 201 is mounted on the housing 210 of the wearable electronic device 100. However, the shape and position of the wing portion 271a are not limited to the above-described example and may be subject to various changes. Hereinafter, the wing portion 271a may also be referred to as the first wing portion 271a.

Referring to FIG. 13, in an embodiment, the wearable member 201 (or the body 271) may include a second wing portion 271b formed to protrude from one surface of the body 271. For example, the second wing portion 271b may be disposed in a partial area of one surface of the body 271, which overlaps the input portion 272a of the button member 272. According to an embodiment, the wing portion 271a may include at least one second opening 2712 through which at least one extension portion 272b of the button member 272 passes. For example, the example described with reference to FIG. 13 and the example described with reference to FIGS. 11 and 12 are not exclusive with each other, and may be combined with each other.

Referring to FIG. 14, in an embodiment, a plurality of wing portions 271a and 271b may be provided on different sidewalls of the body 271. For example, the plurality of wing portions 271a 271b may include a first wing portion 271a protruding from at least one of the sidewalls in the second axial direction (e.g., the X-axis direction). For example, a pair of first wing portions 271a may be formed to protrude from the two sidewalls, respectively. For example, the plurality of wing portions 271a and 271b may include a second wing portion 271b formed to protrude from one surface of the body 271 including an area overlapping the input portion 272a of the button member 272.

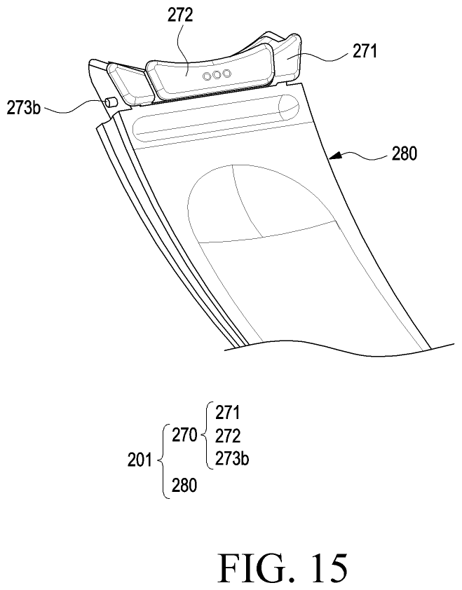

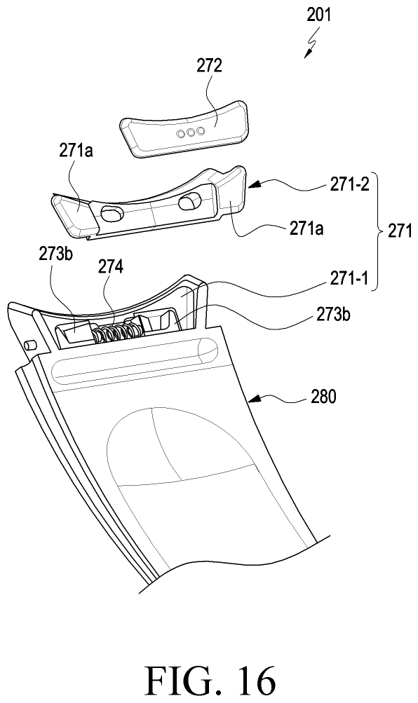

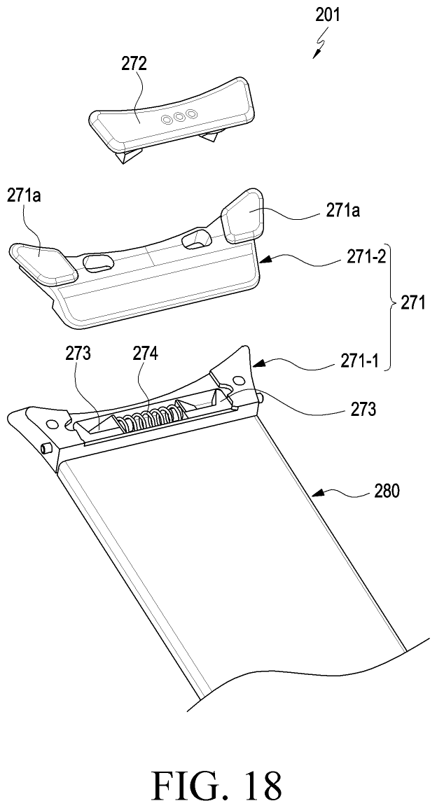

FIG. 15 is a perspective view illustrating the wearable member 201 in the wearable electronic device 100 according to various embodiments. FIG. 16 is an exploded perspective view illustrating the wearable member 201 of FIG. 15 according to various embodiments. FIG. 17 is a perspective view illustrating the wearable member 201 in the wearable electronic device 100 according to various embodiments. FIG. 18 is an exploded perspective view illustrating the wearable member 201 of FIG. 17 according to various embodiments.

The configuration of the wearable member 201 in FIGS. 15, 16, 17 and 18 (which may be referred to as FIGS. 15 to 18) may be wholly or partially the same as or similar to the configuration of the wearable member 201 in FIGS. 11 to 14. For the link assembly 270 and the strap 280 of FIGS. 15 to 18, the link assembly 270 and the strap 280 of FIGS. 11 to 14 may be referred to, respectively. For some of the components, the description of the components to which the same reference numerals are assigned in the previously referenced drawings may be applied, and a redundant description may not be repeated here. The wearable member 201 of FIGS. 15 to 18 will be described with a focus on the differences from the wearable member 201 described with reference to FIGS. 5 to 14.

The wearable member 201 according to various examples of the disclosure may include the strap 280 made of various materials.

Referring to FIGS. 15 and 16, in an embodiment, the wearable member 201 may include the link assembly 270 and the strap 280. According to an embodiment, the link assembly 270 may include the body 271, the button member 272, at least one spring bar 273, and/or the spring member 274.

Referring to FIGS. 15 and 16, in an embodiment, the body 271 of the link assembly 270 may include a first body portion 271-1 fixed to the strap 280 and a second body portion 271-2 connected to the first body portion 271-1. For example, the first body portion 271-1 and the strap 280 may be formed integrally. For example, the second body portion 271-2 and the first body portion 271-1 may be formed to be engaged with each other. For example, an internal space in which the at least one spring bar 273 and the spring member 274 are disposed may be formed between the second body portion 271-2 and the first body portion 271-1. According to an embodiment, the first body portion 271-1 may provide the internal space, and the second body portion 271-2 may be disposed to close the internal space. For example, the strap 280 illustrated in FIGS. 15 and 16 may be formed to include various flexible materials (e.g., a molded body or rubber).

Referring to FIGS. 17 and 18, in an embodiment, the wearable member 201 may include the link assembly 270 and the strap 280. In an embodiment, the link assembly 270 may include the body 271, the button member 272, at least one spring bar 273, and/or the spring member 274.

Referring to FIGS. 17 and 18, in an embodiment, the body 271 of the link assembly 270 may include the first body portion 271-1 fixed to the strap 280 and the second body portion 271-2 connected to the first body portion 271-1. For example, the first body portion 271-1 and the strap 280 may be formed integrally. For example, the second body portion 271-2 and the first body portion 271-1 may be formed to be engaged with each other, and include concave or convex portions that are mechanically coupled to each other, respectively. For example, an internal space in which the at least one spring bar 273 and the spring member 274 are disposed may be formed between the second body portion 271-2 and the first body portion 271-1. According to an embodiment, the first body portion 271-1 may provide the internal space, and the second body portion 271-2 may be disposed to close the internal space. According to an embodiment, the first body portion 271-1 may be formed to extend to surround a portion of one surface of the strap 280. For example, the strap 280 illustrated in FIGS. 17 and 18 may be formed to include a metal, and may include a mesh pattern.

The example of the wearable member 201 illustrated in FIGS. 15 and 16 and/or the example of the wearable member 201 illustrated in FIGS. 17 and 18 are not mutually exclusive with the example of the wearable member 201 illustrated in FIGS. 4 to 14, and they may be combined at least partially with each other.

A wearable member of a wearable electronic device may be detachably connected to a housing using a pin of a spring hinge bar provided in a link assembly. For example, the hinge bar may be provided to be operated by pressing a lever or a button disposed in the link assembly. The lever or the button is too small to be operated. Moreover, when a direction in which the lever or the button is pressed intersects a direction in which the wearable member is removed on the same plane, it is difficult to operate the lever or the button with one hand. In general, a strap of a mounting member may be fixedly coupled to the link assembly, and thus there is a disadvantage in that the link assembly also has to be purchased in order to replace the strap.

An embodiment of the disclosure provides a wearable electronic device including a wearable member with a strap and a link assembly which may be separated from each other.

An embodiment of the disclosure provides a link assembly in which the area of an input portion of a button member is large to improve the usability of the button member, and an input assembly is removable by an easy operation of pulling the link assembly in an opposite direction to a housing while holding the link assembly to press the input portion, and a wearable electronic device including the same.

A wearable electronic device (e.g., 100 in FIGS. 1 to 3 and/or 100 in FIGS. 4 and 11) according to an example embodiment of the disclosure may include: a housing (e.g., 110 in FIGS. 1 and 2 and/or 210 in FIGS. 4 and 11) and a wearable member (e.g., 150 and 160 in FIGS. 1 and 2, 201 in FIG. 3, and/or 201 in FIGS. 4 to 7, FIG. 9, and FIGS. 11 to 18) comprising a strap (or band). The housing may include a concave seating area (e.g., 217 in FIG. 4) formed on at least a portion of a side surface (e.g., the side surface 210C in FIG. 4) thereof. The wearable member may be detachably connected to the seating area. The seating area may include at least one first connecting portion (e.g., 211a in FIG. 4) on two sidewalls in one axial direction. The wearable member may include a link assembly (e.g., 270 in FIGS. 4 to 18) detachably coupled to the seating area, and a strap (e.g., 280 in FIGS. 4 to 7, FIG. 9, and FIGS. 11 to 18). The link assembly may include a pair of first sidewalls (e.g., 271c in FIGS. 4 and 5) facing the two sidewalls of the housing, respectively. The link assembly may include at least one second connecting portion (e.g., 273b in FIGS. 5 to 10 and FIGS. 13 to 18) disposed on a portion of the first sidewalls and configured to be engaged with the first connecting portion. The strap may include a first portion (e.g., 281 in FIGS. 5 and 6) surrounding at least a portion of the link assembly, and/or a second portion (e.g., 282 and 283 in FIGS. 5 and 6) extending from the first portion. At least a portion of the first portion may be disposed between the seating area and the link assembly.

In an example embodiment, the link assembly may include a body (e.g., 271 in FIGS. 4 to 18) including the first sidewalls, a button member comprising a button including an input portion at least partially exposed from an outer surface of the body, and/or a plurality of spring bars (e.g., 273 in FIGS. 8 and 10) disposed within the body, and/or a spring member (e.g., 274 in FIGS. 8 and 10) including a spring disposed between the spring bars. The button member may be connected to the body and configured to move in a first axial direction. The spring bars may be connected to a portion of the button member.

In an example embodiment, the body may include at least one wing portion (e.g., 271a in FIG. 8, FIG. 10, and FIGS. 11 to 14) formed to protrude on at least a portion of one of the pair of first sidewalls. The wing portion may be disposed to face a portion of the housing.

In an example embodiment, the first portion may be configured to have at least a portion of an area overlapping the input portion penetrated.

In an example embodiment, the spring bars (e.g., 273-1 and 273-2 in FIGS. 8 and 10) may be provided as a pair, each including a first end and a second end (e.g., 273c in FIGS. 8 and 10) being opposing ends in a second axial direction intersecting the first axial direction.

In an example embodiment, the pair of spring bars may include second connecting portions (e.g., 273b in FIGS. 4 to 18) at the first ends, respectively, and may be disposed to have the second ends of each of the pair of spring bars facing each other with the spring member interposed therebetween.

In an example embodiment, the button member may include at least one extension portion (e.g., 272b in FIGS. 8 and 10) extending from the input portion into the body. The extension portion may include a first inclined surface (e.g., 272c in FIGS. 8 and 10) at an end opposite to an end connected to the input portion.

In an example embodiment, the body may further include a first opening (e.g., 2711 in FIGS. 8 and 10) penetrating in the first axial direction to allow the extension portion to pass therethrough.

In an example embodiment, at least some of the spring bars may include a second inclined surface (e.g., 273a in FIGS. 8 and 10) configured to engage with the first inclined surface.

In an example embodiment, based on the button member moving in the first axial direction, the pair of spring bars may be configured move in the second axial direction intersecting the first axial direction based on movement of the second inclined surface relative to the first inclined surface.

In an example embodiment, based on the button member moving toward the spring bars along the first axial direction, the pair of spring bars may be configured to move away from each other, and the second connecting portion may be configured to protrude from the outer surface of the body.

In an example embodiment, the strap may be disposed to not overlap the first sidewalls.

In an example embodiment, the second portion may include a pair of the second portions extending from the first portion. The pair of second portions may be disposed parallel, facing each other.

In an example embodiment, the second portions may be configured to be changeable from a state of facing each other to a state of moving away from each other to form an angle. The link assembly may be detachably connected to the strap.

In an example embodiment, the strap may further include an intermediate member (e.g., 274 in FIGS. 5 and 6) disposed between the second portions and detachably connected to at least one of the second portions.

A wearable electronic device (e.g., 100 in FIGS. 1 to 3 and/or 100 in FIGS. 4 and 11) according to an example embodiment of the disclosure may include: a housing (e.g., 110 in FIGS. 1 and 2 and/or 210 in FIGS. 4 and 11) and a wearable member (e.g., 150 and 160 in FIGS. 1 and 2, 201 in FIG. 3, and/or 201 in FIGS. 4 to 7, FIG. 9, and FIGS. 11 to 18) comprising a strap (or band). The housing may include a concave seating area (e.g., 217 in FIG. 4) formed on at least a portion of a side surface (e.g., the side surface 210C in FIG. 4) thereof. The wearable member may be detachably connected to the seating area. The wearable member may include a link assembly (e.g., 270 in FIGS. 4 to 18) detachably coupled to the seating area, and a strap (e.g., 280 in FIGS. 4 to 7, FIG. 9, and FIGS. 11 to 18) connected to surround at least a portion of the link assembly. The link assembly may include a body (e.g., 271 in FIGS. 4 to 18), a button member (e.g., 272 in FIGS. 4 to 18), and/or a plurality of spring bars (e.g., 273 in FIGS. 8 and 10). The button member comprising a button may include an input portion (e.g., 272a in FIGS. 8 and 10). The input portion may extend into the internal space through an opening formed on the body. The spring bars may be disposed in the internal space, and disposed to face each other with a spring member including a spring therebetween. Extension portions and/or the spring bars may include inclined surfaces (e.g., 272c and 273a in FIGS. 8 and 10) engaged with each other, respectively. The input portion may at least partially overlap one surface of the body facing the input portion.

In an example embodiment, the seating area may include a first connecting portion on each of two sidewalls in one axial direction. The body may include a pair of first sidewalls (e.g., 271c in FIGS. 4 and 5) facing the two sidewalls of the housing, respectively. The spring bars may be disposed to protrude through openings (e.g., 2712 in FIGS. 8 and 10) formed on the first sidewalls. Second connecting portions (e.g., 273b in FIGS. 4 to 18) configured to be engaged with the first connecting portions may be included. The strap may not overlap the at least one first sidewall.

In an example embodiment, the strap may include a first portion (e.g., 281 in FIGS. 5 and 6) surrounding at least a portion of the link assembly and/or second portions (e.g., 282 and 283 in FIGS. 5 and 6) extending from the first portion. The first portion may have at least a portion of an area overlapping the input portion penetrated. For example, the first portion may include an opening formed in the area overlapping the input portion, and the input portion may be exposed to the outside through the opening of the first portion.

In an example embodiment, the body may include a wing portion (e.g., 271a in FIG. 8, FIG. 10, and FIGS. 11 to 14) protruding on a portion of at least one of the pair of first sidewalls. The wing portion may overlap a portion of the housing.

According to an embodiment of the disclosure, the design and/or material of a strap may be easily changed according to the purpose of use of the wearable electronic device and a user's preference, and the usability of a wearable electronic device may be increased.

The effects derived from various embodiments of the disclosure are not limited to the above-described effects, and may be extended in various manners without departing from the scope and spirit of the disclosure.

It is to be understood that a singular form such as “a”, “an”, or “the” includes plural referents, unless the context clearly dictates otherwise. Therefore, for example, “a surface of a component” may be understood to include one or more of the surfaces of the component.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A wearable electronic device comprising:
a housing including a concave seating area formed on at least a portion of a side surface of the housing; and
a wearable member comprising a strap detachably connected to the seating area,
wherein the seating area includes at least one first connecting portion on two sidewalls in one axial direction of the housing, and
wherein the wearable member includes:
a link assembly detachably coupled to the seating area, and including a pair of first sidewalls facing the two sidewalls of the housing, respectively; and at least one second connecting portion disposed on a portion of the first sidewalls and configured to engage with the first connecting portion; and
a strap including a first portion surrounding at least a portion of the link assembly, and a second portion extending from the first portion, and
wherein at least a portion of the first portion is disposed between the seating area and the link assembly.

2. The wearable electronic device of claim 1, wherein the link assembly includes:
a body including the first sidewalls;
a button member comprising a button connected to the body configured to move in a first axial direction and including an input portion at least partially exposed from an outer surface of the body;
a plurality of spring bars disposed within the body and connected to a portion of the button member; and
a spring member including a spring disposed between the spring bars.

3. The wearable electronic device of claim 2, wherein the body includes at least one wing portion protruding on at least a portion of one of the pair of first sidewalls, and
wherein the wing portion is disposed to face a portion of the housing.

4. The wearable electronic device of claim 2, wherein the first portion is formed to have at least a portion of an area overlapping the input portion penetrated.

5. The wearable electronic device of claim 2, wherein the spring bars are provided as a pair, each including a first end and a second end in a second axial direction intersecting the first axial direction.

6. The wearable electronic device of claim 5, wherein the pair of spring bars include second connecting portions at the first ends, respectively, and are disposed to have the second ends of each of the pair of spring bars facing each other with the spring member interposed therebetween.

7. The wearable electronic device of claim 2, wherein the button member includes at least one extension portion extending from the input portion into the body, and
wherein the extension portion includes a first inclined surface at an end opposite to an end connected to the input portion.

8. The wearable electronic device of claim 7, wherein the body further includes a first opening penetrating in the first axial direction to allow the extension portion to pass therethrough.

9. The wearable electronic device of claim 7, wherein at least some of the spring bars includes a second inclined surface engaged with the first inclined surface.

10. The wearable electronic device of claim 9, wherein based on the button member moving in the first axial direction, the pair of spring bars are configured to move in the second axial direction intersecting the first axial direction based on movement of the second inclined surface relative to the first inclined surface.

11. The wearable electronic device of claim 10, wherein based on the button member moving toward the spring bars along the first axial direction, the pair of spring bars are configured to move away from each other, and the second connecting portion is configured to protrude from the outer surface of the body.

12. The wearable electronic device of claim 1, wherein the strap is disposed to not overlap the first sidewalls.

13. The wearable electronic device of claim 12, whereas the second portion is provided as a pair of second portions extending from the first portion, and
wherein the pair of second portions are disposed in parallel, facing each other.

14. The wearable electronic device of claim 13, wherein the second portions are configured to be changeable from a state of facing each other to a state of moving away from each other to form an angle, and the link assembly is detachably connected to the strap.

15. The wearable electronic device of claim 13, wherein the strap further includes an intermediate member disposed between the second portions and detachably connected to at least one of the second portions.
